(19) United States
(12) Patent Application Publication
(10) Pub. No.: US 2003/0127530 A1
(43) Pub. Date: Jul. 10, 2003

(54) Device and method for cleaning glue-application nozzles

(76) Inventor: Jirko Heide, Schwarzenbek (DE)

Correspondence Address: VENABLE, BAETJER, HOWARD AND CIVILETTI, LLP, P.O. BOX 34385, WASHINGTON, DC, 20043-9998, US

(21) Appl. No.: 10/322,798

(22) Filed: Dec. 19, 2002

(30) Foreign Application Priority Data
Dec. 21, 2001 (DE) 101 63 744.6

(51) Int. Cl. B05B 15/02; B05D 1/00; F23J 1/00

(52) U.S. Cl. 239/1; 239/106; 239/120; 239/112; 134/19; 134/21; 134/34; 134/174; 134/168 R

(57) ABSTRACT

A device and method for cleaning a glue-application nozzle is provide. An apparatus defines at least one liquid discharge opening for discharging liquid onto the glue-application nozzle. A suctioning device is coupled to the apparatus for suctioning the discharged liquid.

### CROSS-REFERENCE TO RELATED APPLICATION

This application claims the priority of German Patent Application No. 101 63 744.6,filed Dec. 21, 2001. The disclosure of the foregoing priority application and of each and every U.S. and foreign patent and patent application mentioned herein are incorporated herein by reference.

### BACKGROUND OF THE INVENTION

The invention relates to a cleaning device and method for one or more glue-application nozzles that spread glue onto materials used in the tobacco processing industry, in particular, packaging materials, cigarette paper and coating paper.

Glue-application systems, in particular, cold-setting adhesive systems, are sources of contamination in packaging machines and cigarette production machines. The time required for cleaning and correcting the problems caused by glue contamination reduces the capacity of the production lines. Specifically, particles and residues of dispersion adhesives adhering to and around the nozzle-opening regions of the glue-application devices lead to problems, for example, an unclean or uneven adhesive application, plugged nozzles or the splattering of glue particles. Glue-application system manufacturers and machine producers attempt to prevent these problems, for example, with the aid of locking bars or rotating sponge rollers in a water bath. The above-mentioned methods all are subject to wear on the cleaning device and/or the glue application nozzles and require regular maintenance and control, thus leading to correspondingly high expenditures.

International patent application WO 01/02 101 A1 discloses a cleaning device that uses an atomized jet of a liquid under pressure to clean a glue-application device of residual glue. According to one embodiment disclosed in WO 01/02 101 A1, the liquid, which contains impurities such as the excess glue, is collected and suctioned off to another location.

The cleaning device disclosed in WO 01/02 101 A1 has a relatively large design and does not automatically clean the glue-application nozzles because the glue-application nozzles cannot be cleaned during operation of the machine. The device disclosed in the aforementioned document is therefore only suitable for cleaning glue-application disks or plates.

A device for spreading glue onto enveloping material blanks for cigarette packs with a glue-application nozzle is known from German patent document 196 39 260 A1. This reference in particular discloses a cleaning mechanism that acts from the outside upon the glue-application nozzle. The cleaning mechanism is arranged on a catch container and includes a spray nozzle. The cleaning mechanism can also be embodied in the form of a rotating brush.

### SUMMARY OF THE INVENTION

It is an object of the invention to provide a device and method for cleaning glue-application nozzles. The device and method preferably cause little wear on the nozzles and require little maintenance. Adhering glue particles on the glue-application device are removed thoroughly and reliably.

The above and other objects are accomplished according to the invention by the provision of a cleaning device for a glue-application nozzle, for example, a nozzle for spreading glue onto materials in the tobacco processing industry and/or onto packaging materials. The device has at least one liquid discharge opening for subjecting the at least one glue-application nozzle with liquid. The cleaning device furthermore includes a suctioning device for suctioning off contaminated liquid after the at least one glue-application nozzle is subjected with the liquid.

The cleaning device according to the invention reliably cleans the glue-application nozzles with relatively low wear.

According to one embodiment of the invention, the liquid is suctioned from a region at or near the at least one glue-application nozzle. The suctioning device is preferably arranged such that liquid contaminated with glue is suctioned off essentially completely from a region near the at least one glue-application nozzle. As a result, other components, for example, a machine in the tobacco processing industry or a packaging machine, are not adversely affected. The cleaning is preferably effected during a break in the glue spreading operation of at least a part of the packaging machine and/or the machine in the tobacco processing industry. As a result of this measure, no additional loss of time resulting from cleaning the glue-application nozzle and/or nozzles is incurred.

The at least one liquid discharge opening is preferably located at a distance to the at least one glue-application nozzle. A defined cleaning of the glue-application nozzle is possible as a result of the invention.

According to another embodiment of the invention, the device for subjecting the at least one glue-application nozzle with a liquid is designed such that a liquid jet can be directed toward the at least one glue-application nozzle. A particularly compact cleaning device is realized. The liquid jet is preferably directed toward the front of the glue-application nozzle, especially directly counter or at least partially counter to the glue application device, i.e., counter to the direction in which glue flows through the glue-application nozzle when glue is spread onto the materials. Of course, the offset in timing must preferably be taken into consideration. Accordingly, the above statement is applicable only to the direction of the liquid jet and the glue.

A high-pressure liquid jet is particularly effective in removing glue residues. The high pressure is generated by a pump that puts the liquid under pressure. A sufficiently strong liquid jet, in particular water, can be generated and focused directly onto the contaminated nozzle area to remove glue residues and other contamination.

According to another embodiment of the invention, the cleaning device is arranged opposite the at least one glue-application nozzle, in particular below it, such that the glue-application nozzle can remain in the glue application position even during the cleaning operation. A particularly compact cleaning device can be realized by additionally providing a casing that defines or contains the at least one liquid discharge opening along with an opening that can be connected to the suctioning device. In addition, at least a part of the at least one glue-application nozzle is enclosed by the casing in a cleaning position. This design securely prevents liquid from being discharged into the area surrounding the nozzle, thus contaminating and/or wetting other parts of the remaining machinery, e.g. the packaging or processing machine. The arrangement of the suctioning device itself at least a portion of the suctioning device or suctioning opening near the glue-application nozzle prevents liquid from reaching an undesirable area.

The casing of the cleaning device is preferably movable in the direction of glue-application nozzle, particularly in linear direction to allow for a particularly simple and easy cleaning. Thus, operational breaks of the packaging machine or machines in the tobacco processing industry are not extended as a result of the cleaning of the glue-application nozzle and/or nozzles.

If the casing is designed such that the at least one glue-application nozzle and casing define a cavity, little or no liquid can escape into the outside. It is therefore preferable if the casing opening that accommodates the glue-application nozzle is designed to fit precisely, so as not to leave a gap between the casing and the glue-application nozzle after the casing is pivoted and/or moved in the direction of the glue-application nozzle into the cleaning position.

The device for subjecting the at least one glue-application nozzle with liquid preferably comprises at least one nozzle for emitting a defined liquid jet. Alternatively, the device includes a liquid discharge opening.

The suctioning device preferably comprises a pump unit or an ejector for suctioning the liquid. The ejector in particular refers to a jet pump or a steam jet pump for pumping liquid and/or atomizing liquid. Furthermore, if the casing has a front that points in the direction of at least one glue-application nozzle that is designed for guiding the material onto which glue is spread, no other guide elements are required at this location. Thus, in this embodiment, the casing performs a dual function.

According to another aspect of the invention, there is provided a method for cleaning a glue-application nozzle on a machine in the tobacco processing industry and/or on a packaging machine. A liquid jet is sprayed onto the glue-application nozzle to remove impurities on and around the glue-application nozzle. The method may also include suctioning the liquid and the removed impurities out of the area near the glue-application nozzle.

The method according to the invention provides an efficient cleaning of the glue-application nozzles. In particular, no liquid or very little liquid spreads to the area surrounding the glue-application nozzle because the liquid is suctioned off. The suctioning operation preferably occurs at the same time as the liquid is admitted, thus making it possible to immediately suction off all of the liquid.

For a particularly effective method that requires only small amounts of suction air, the cleaning preferably occurs in a cavity with a vacuum or at a pressure less than atmospheric. The liquid jet in particular is directed with comparably high pressure onto the glue-application nozzle. The ratio of liquid pressure to suctioning capacity preferably is adjusted such that the liquid jet is not or not essentially deflected on the way to the glue-application nozzle, but is still suctioned off completely.

At least a portion of the cleaning device is preferably moved in the direction of the glue-application nozzle prior to cleaning of the glue-application nozzle. For one particularly preferred embodiment, the method is realized during an operational break of the packaging and processing machine. Owing to this preferred method, no additional time is required for the operational break of cleaning the glue-application nozzle.

An extremely effective removal of the glue residues is using a pulsating liquid jet.

The removal of the glue residues and/or the contamination is improved if a heated liquid is used for generating the liquid jet. Furthermore, the glue residues and/or the impurities can be removed easier if a cleaning agent is added to the liquid, for example, a solvent for glue.

The nozzle can additionally be flushed from the inside, resulting in an improved cleaning, if glue is pumped through the glue-application nozzle during at least part of the cleaning operation.

For the purpose of this invention, the term “close” also includes the immediately surrounding area. Within the framework of this invention, the term “impurities” also refers to glue residues.

### BRIEF DESCRIPTION OF THE DRAWINGS

The invention is explained in the following with the aid of exemplary embodiments and by referring to the drawings, without restricting the general inventive idea.

FIG. 1 is a cross-sectional side view of a cleaning device according to the invention.

FIG. 2 is a schematic representation of another embodiment of the cleaning device according to the invention.

FIG. 3 is a view of the embodiment of FIG. 2 in a different position relative to a glue-application nozzle.

FIG. 4 is a view of the embodiment of FIG. 2, and illustrates glue being spread onto a material.

FIG. 5 is a schematic representation of another embodiment of the invention.

FIG. 6 is a schematic representation of another embodiment of the invention.

FIG. 7 is a schematic representation of another embodiment of the invention.

### DETAILED DESCRIPTION OF THE INVENTION

Identical or corresponding parts are given the same reference numerals in the drawings and will not be introduced again.

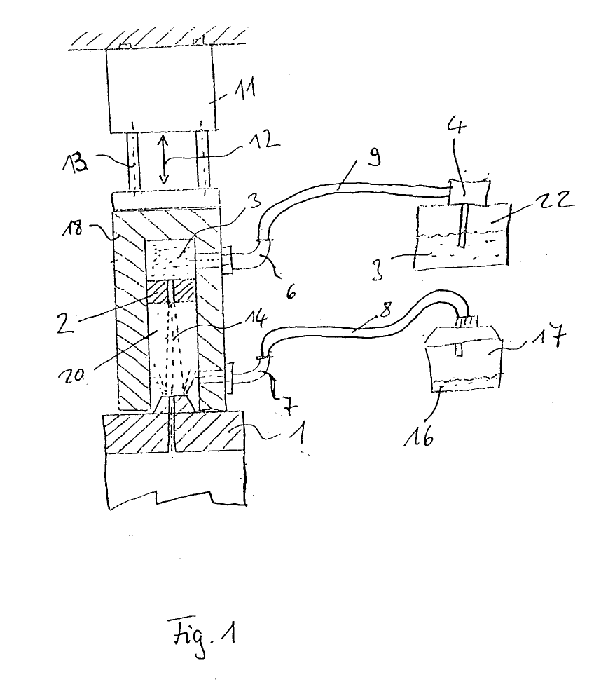

FIG. 1 shows a cleaning device for cleaning a glue-application nozzle 1. A cavity 20 is defined inside a casing 18 by a cleaning nozzle 2, the casing walls of casing 18 and the glue-application nozzle 1. Inside the cavity 20, a water jet 14 is focused directly onto the glue-application nozzle 1. To generate the water jet 14, cleaning water 3 is pumped with a pump 4 from a water container 22 under pressure through a hose 9 and a connecting element 6 into the casing 18 and onto the cleaning nozzle 2. As a result of a relatively high pressure, the cleaning water 3 is pushed through the nozzle and generates the water jet 14. The pump can be, for example, pump model AT20, manufactured by the German company Almatec.

The high-pressure water jet, e.g. with a pressure of 4 to 8 bar but preferably 6 bar, hits the glue-application nozzle 1 that is preferably arranged below the cleaning device and removes glue residues and other impurities from the glue-application nozzle 1. A suctioning device 17 installed near the glue-application nozzle suctions off the respective mixture of cleaning water 3 and glue residues and/or contamination as contaminated water 16. The suctioning device 17 generates a pressure less than atmospheric or a vacuum inside the cavity 20 to suction the contaminated water. The suctioning device 17 is connected to the cavity 20 via a hose 8, a suction pipe 7 and an opening in the casing 18. The cleaning device is ideally arranged precisely opposite the glue-discharge opening of the glue-application nozzle 1.

During breaks in the production of the machine, the cleaning device is fitted onto the glue-application nozzle 1 with the aid of a pivoting device and/or a translational device, for example, a short-stroke cylinder 11 in connection with a guide 13. The short-stroke cylinder 11 can be, for example, a product of the German company Festo. The cleaning device is moved in direction 12 with the short-stroke cylinder 11. After the casing 18 has been fitted onto the glue-application nozzle 1, a sufficiently strong water jet or liquid jet 14 is generated and focused directly onto the contaminated nozzle region. The suctioning device is also activated.

Owing to its high speed, the water jet 14 removes the glue residues and other contamination. The suctioning device 17 removes the resulting atomized fog and/or contaminated water and prevents water from leaking into the area around the nozzle. To improve the cleaning effect, the glue valve and/or the glue-application nozzle 1 can also be operated briefly, such that the outflow of glue 32 can additionally aid cleaning of the inside portion of the glue-application nozzle 1.

The cleaning nozzle 2 and the suctioning device are combined to form a compact component in the casing 18. In the operating state, they form a chamber and/or cavity around the glue-application nozzle 1 to be cleaned. A pressure of less than atmospheric or a vacuum is created in the cavity, thus making it unnecessary to have an involved seal at the contact location between glue-application nozzle 1 and cleaning device. The cleaning water 3 can be heated for a better cleaning effect and/or cleaning agents can additionally be used.

The necessary water pressure is generated with the pump 4, for example a membrane pump manufactured by the German company Almatec. The pump 4 is located on a supply container, water container 22 or other water supply system. A flexible hose 9 connects the pump 4 to the flushing head and/or the casing 18. Different nozzles, for example, nozzles produced by the company Spraying Systems, can optionally be used inside the casing for generating specific, desired jet characteristic.

The mixture of water, glue and other contaminants can be suctioned out of the casing in different ways. One method is shown in FIG. 1, which depicts the suctioning device 17. In this case, the solution resulting from the cleaning flows into the catch container of the suctioning device 17 and should be removed regularly. The suctioning device 17 can be a model AS 1100 INOX, manufactured by Einhell, a company located in Lindau, Germany.

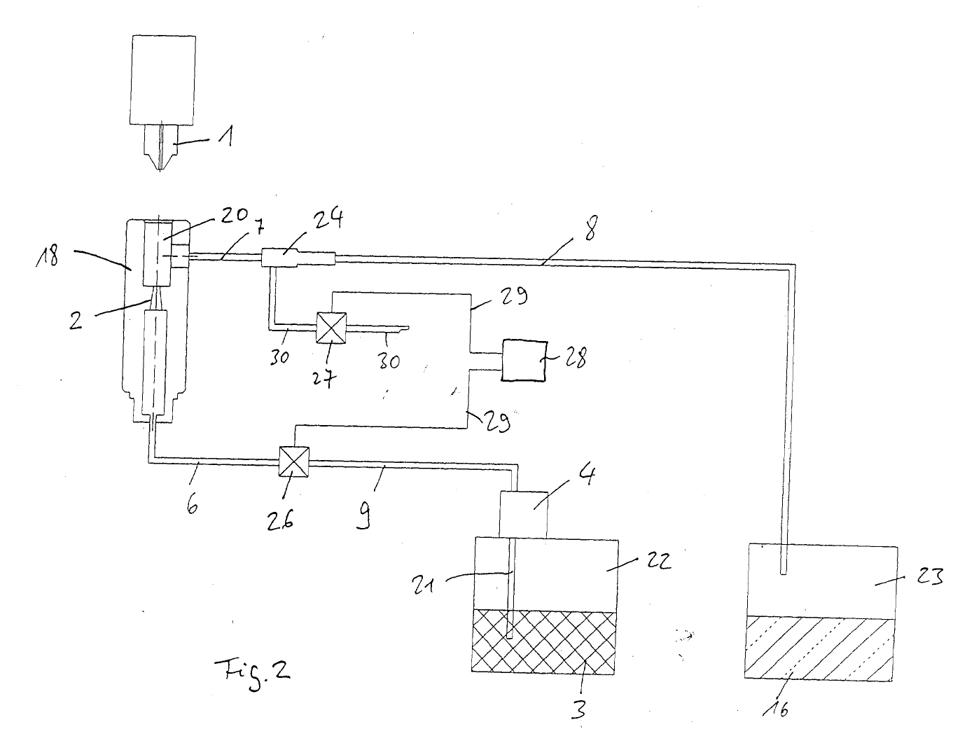

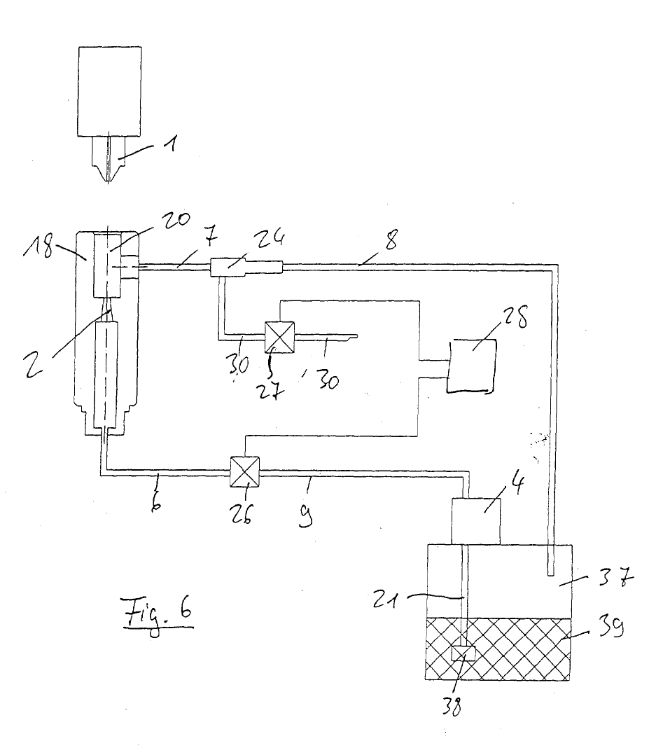

A different variant of the invention uses a compressed-air ejector 24 and is shown in FIGS. 2 to 6. With the aid of suction air made available to the ejector 24 via an air-intake pipe 30, the ejector 24 generates a pressure less than atmospheric or a vacuum in the suction pipe 7. Thus, the liquid is moved to the hose 8 and finally into the contaminated water container 23 and/or, as shown in FIG. 6, into the mixed water container 37. Ejectors, for example, ejectors produced by the German companies Fipa or Volkmann can be used. As an example, Volkmann model PV100 can be used. The Volkmann ejector has an air consumption, for example, of 0.95 Nm³/min at 6 bar and preferably operates with a vacuum at 300 mbar.

FIG. 2 shows an intake pipe 21 by which the cleaning water 3 is fed from the water container 22 via a pump 4 through the cleaning nozzle 2. A shut-off valve 26 is installed inline in the system, between the connecting element 6 and the hose 9, and functions to respectively control the supply of cleaning water 3. For this, the shut-off valve 26 is connected via a line 29 to a control device 28. The suctioning capacity and/or the suctioning operation is also controlled by the ejector 24 and via a shut-off valve 27, which controls the suction air in the air intake pipe 30. The shut-off valve 27 is furthermore connected via a line 29 to the control device 28. The shut-off valves 26 and 27 can be opened and closed with the control device 28 for desired cycles and/or desired times. FIG. 2 shows a position in which the casing 18 is at a distance to the glue-application nozzle 1. In this position, the cleaning device is not in operation. No water jet 14 is generated and the suctioning device is not activated.

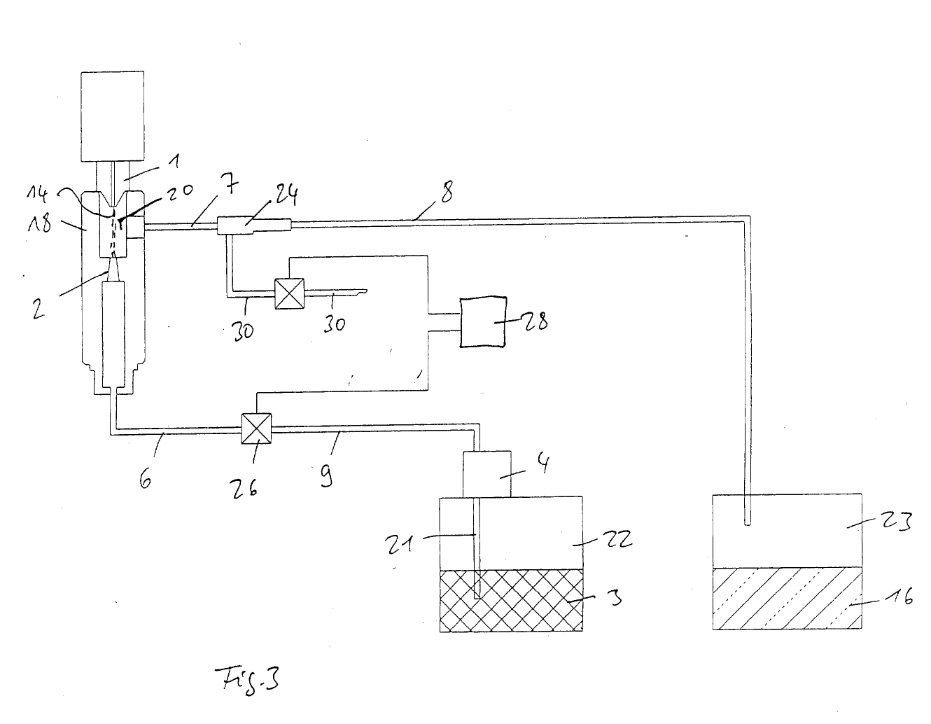

The schematic representation in FIG. 3 is the same representation as in FIG. 2, except that the relative position of the casing 18 to the glue-application nozzle 1 is different. In this exemplary embodiment, the glue-application nozzle 1 fits against the casing 18 and/or has been moved in the direction of the glue-application nozzle until it makes contact with the nozzle 1. In this position, the glue-application nozzle 1 can be cleaned.

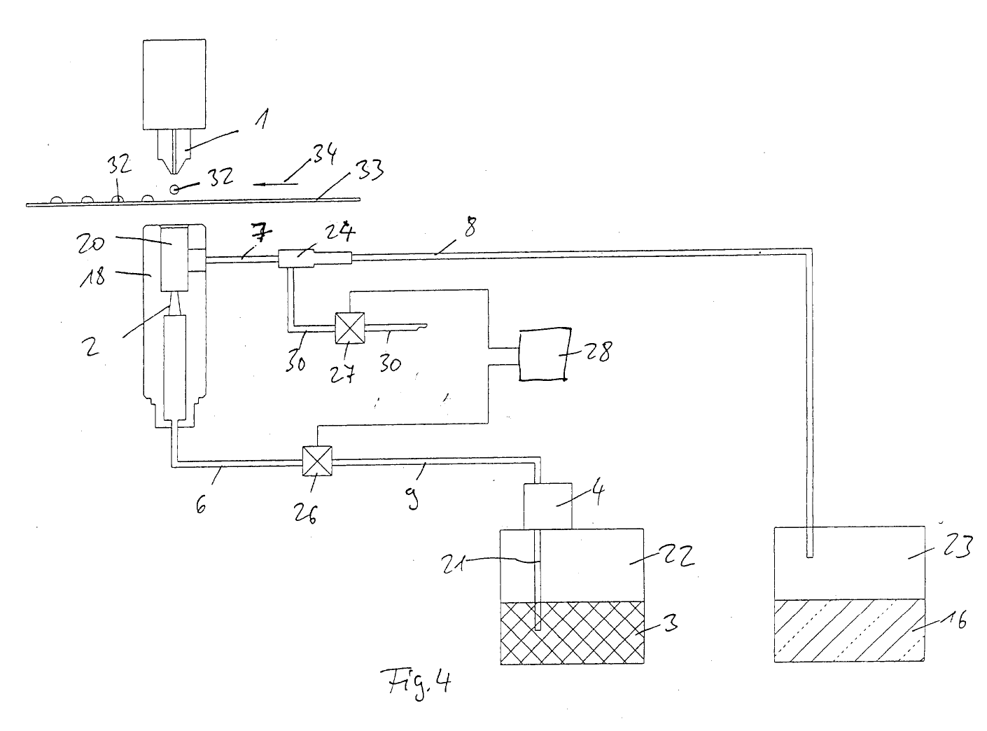

The exemplary embodiment shown in FIG. 4 illustrates how the glue-application nozzle 1 spreads the glue 32 onto a blank 33 conveyed in conveying direction 34.

In this position and/or during the predetermined function of the glue-application nozzle 1, no water jet 14 is generated and there is no suctioning operation.

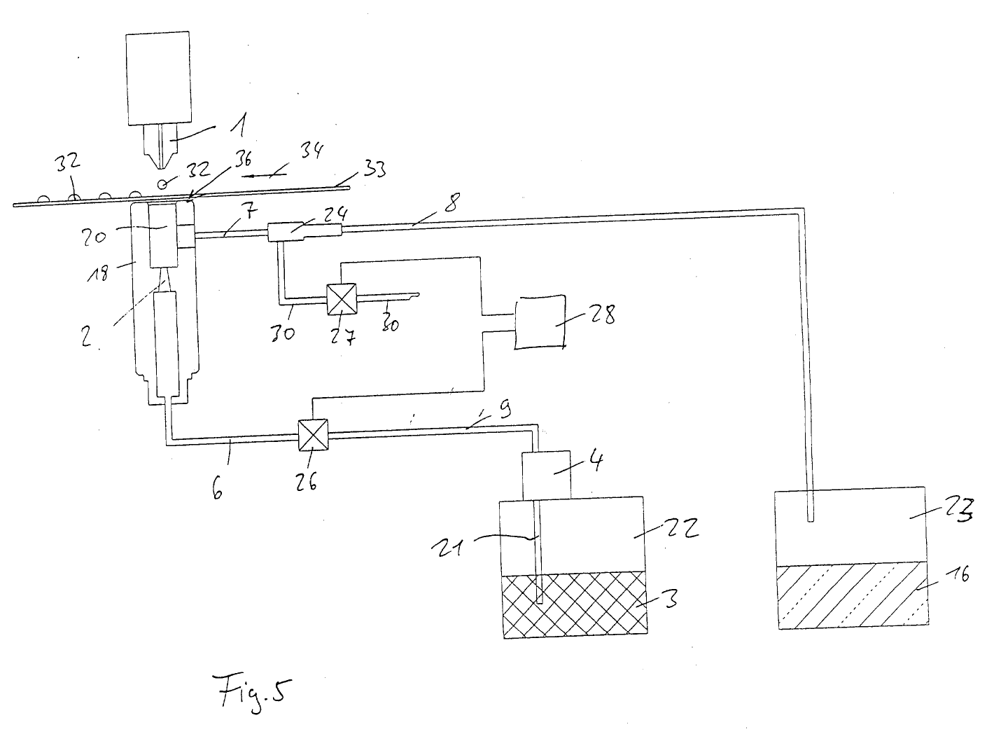

In order to support and/or guide the blank 33, FIG. 5 shows that the casing 18 is moved to the region of blank 33 such that a guide surface 36 makes contact with the blank 33 and guides the blank 33. In this embodiment, the casing 18 serves a dual function.

FIG. 6 shows a schematic view of another exemplary embodiment of a cleaning device according to the invention in which the cleaning liquid is used in a closed system. For this embodiment, mixed water 39 is filtered through a filter 38, suctioned in via an intake pipe 21, and supplied to the cleaning nozzle 2 via the hose 9, the shut-off valve 26 and the connecting element 6. The correspondingly contaminated water and/or mixed water is then again supplied by an ejector 24 to the mixed water container 37 via the suction pipe 7, the ejector 24 and the hose 8. A filter 38 can also be provided for the exemplary embodiments shown in FIGS. 1 to 5.

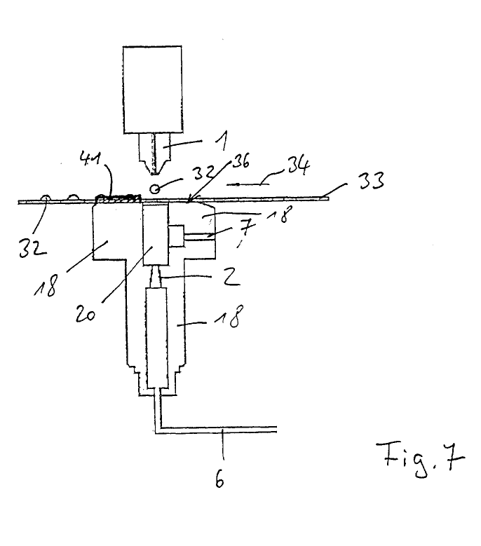

FIG. 7 shows another embodiment of the invention. The cleaning device of this embodiment has a longer and/or larger guide surface 36. The material onto which the glue is spread is positioned precisely in the region of the glue-application nozzle 1. Corresponding guide rails 41, guide plates, pressure blocks or similar measures can be used to position the material. The combination of an extended guide surface 36 and a guide rail 41 is used in the embodiment shown in FIG. 7. The opening into which the glue-application nozzle 1 is inserted for the cleaning operation is flush with the sliding surface and/or the guide surface 36. Alternatively, the suctioning opening of the device can be integrated so as to be flush with a sliding surface of a plate inserted for guiding the material, wherein the glue-application nozzle or the guiding device with suctioning device are designed such that they can be moved. However, it is also possible to provide the material guiding parts in the region of the flushing device with a recess through which the suctioning device can be pivoted against the glue-application nozzle.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A device for cleaning at least one glue-application nozzle, comprising:
an apparatus defining at least one liquid discharge opening for discharging liquid onto the at least one glue-application nozzle; and
a suctioning device coupled to said apparatus for suctioning the discharged liquid.

2. The device according to claim 1, wherein the suctioning device is arranged adjacent to the at least one glue-application nozzle.

3. The device according to claim 1, wherein the at least one liquid discharge opening is located at a distance from the at least one glue-application nozzle.

4. The device according to claim 1, wherein the apparatus includes means for directing a liquid jet onto the at least one glue-application nozzle.

5. The device according to claim 4, wherein the directing means directs the liquid jet directly at a front of the least one glue-application nozzle.

6. The device according to claim 1, wherein the apparatus comprises a pump for discharging the liquid under pressure.

7. The device according to claim 1, wherein the apparatus is arranged such that the liquid discharge opening is opposite and below the at least one glue-application nozzle.

8. The device according to claim 1, wherein the apparatus includes a casing that defines the at least one liquid discharge opening, the casing further defining a suction opening for connection with the suctioning device and a nozzle opening for accommodating at least a portion of the at least one glue-application nozzle.

9. The device according to claim 8, further comprising means for moving the casing toward the at least one glue-application nozzle.

10. The device according to claim 9, wherein the casing and the at least one glue-application nozzle define a cavity in a cleaning position.

11. The device according to claim 1, wherein the apparatus comprises at least one liquid nozzle for discharging the liquid through the liquid discharging opening.

12. The device according to claim 1, wherein the suctioning device comprises at least one of a pump unit and an ejector.

13. The device according to claim 8, wherein the casing has a front portion facing the at least one glue-application nozzle for guiding material on which glue is applied by the at least one glue-application nozzle.

14. A method for cleaning a glue-application nozzle on a machine, comprising:
directing a jet of liquid onto the glue-application nozzle to remove impurities; and
suctioning the liquid and the removed impurities from adjacent the glue-application nozzle.

15. The method according to claim 14, wherein the directing and suctioning occur simultaneously.

16. The method according to claim 14, wherein the directing and suctioning steps include directing and suctioning in a cavity having a pressure less than atmospheric pressure.

17. The method according to claim 14, wherein the directing step includes directing the jet at a high pressure onto the at least one glue-application nozzle.

18. The method according to claim 14, further comprising moving an apparatus for directing the jet of liquid in a direction of the at least one glue-application nozzle into a cleaning position.

19. The method according to claim 14, wherein the directing step includes pulsating the jet.

20. The method according to claim 14, further comprising braking operation of the machine prior to the directing and suctioning steps.

21. The method according to claim 14, further comprising heating liquid for the jet of liquid.

22. The method according to claim 14, further comprising adding a cleaning agent to the liquid.

23. The method according to claim 14, further comprising pumping glue through the at least one glue-application nozzle.
